(19) United States
(12) Patent Application Publication
(10) Pub. No.: US 2016/0282445 A1
(43) Pub. Date: Sep. 29, 2016

(54) POSITION INFORMATION ACQUISITION SYSTEM, TERMINAL, AND METHOD

(71) Applicant: HITACHI, LTD., Tokyo (JP)

(72) Inventors: Shinichi KAWAMOTO, Tokyo (JP); Miyuki HANAOKA, Tokyo (JP)

(73) Assignee: Hitachi, Ltd., Tokyo (JP)

(21) Appl. No.: 15/032,806

(22) PCT Filed: Oct. 3, 2014
(86) PCT No.: PCT/JP2014/076621

§ 371 Date: Apr. 28, 2016

(30) Foreign Application Priority Data
Nov. 1, 2013 (JP) 2013-228430

(51) Int. Cl. G01S 5/02; H04L 29/12

(52) U.S. Cl. CPC G01S 5/0252; H04L 61/6022; H04W 84/12

(57) ABSTRACT

A position information acquisition system has a terminal and a position information acquisition server for acquiring position information for the terminal. The terminal has a radio wave intensity measurement unit for receiving first radio wave intensities of radio waves received by a plurality of access points and associating the received first radio wave intensities with access point identifiers, and a moving/stationary determination unit for determining whether the terminal is moving or stationary. The position information acquisition server has a position information table in which second radio wave intensities of radio waves received from the plurality of access points are associated with position information, and a radio-wave-intensity/position conversion unit for retrieving second radio wave intensities corresponding to the received first radio wave intensities, and acquiring position information corresponding to the retrieved second radio wave intensities.

### TECHNICAL FIELD

The present invention relates to position information acquisition systems, terminals, and methods for acquiring the position information of mobile terminals.

### BACKGROUND ART

Location based services by means of applications which utilize position information obtained by specifying the current positions of mobile terminals using the intensities of radio wave sources or acoustic wave sources, have been widely used.

Patent Literature 1 discloses a technology in which the current position of a mobile station is estimated. In the technology disclosed by Patent Literature 1, plural measurements of radio wave intensities from plural base stations are executed at a measurement site in a service area, the received radio wave intensities are accumulated in association with the measurement site (position) in a radio wave intensity data memory unit, the radio wave intensity data in the radio wave intensity data memory unit is compared with the received radio wave intensities at a target site to be specified (that is to say, the position) in the detection of the position of the mobile station, and a position detection unit estimates the position of the mobile station on the basis of plural radio wave intensity data pieces, which have small errors in the wake of the comparison of the radio wave intensities, using a statistical method. As a result, the position of the mobile station can be estimated with a distance resolution smaller than a distance between any two measurement sites without being limited to the actual measurement sites.

### CITATION LIST

### Patent Literature

Patent Literature 1: Japanese Unexamined Patent Application Publication No. Hei10 (1998)-51840

### SUMMARY OF INVENTION

### Technical Problem

A terminal is taken along by a person, and is moved along with the person's movement, and therefore a wave radio intensity received from a specific radio wave source varies due to this movement. In the technology disclosed in Patent Literature 1, the position of a mobile terminal is estimated by comparing the result of a radio wave intensity measurement executed in moving with information about the radio wave intensities measured beforehand by a mobile terminal staying at a specific position. Therefore there is a problem in that this technology cannot cope with the variation of the radio wave intensity measured in moving.

Although this technology cannot cope with the variation of a radio wave intensity measured by a moving mobile terminal, the CPU power of the mobile terminal is used for measuring the radio wave intensity by the mobile terminal, and therefore the energy of the battery of the mobile terminal and the like are consumed for the operation of the mobile terminal.

A person has few opportunities to use his/her mobile terminal while he/she is moving. Therefore inventors pay notice to the fact that it is unnecessary to detect the position of a mobile terminal while the terminal is moving, and attempts to restrain the energy consumption of the mobile terminal.

### Solution to Problem

A position information acquisition system disclosed by the present invention includes: a terminal having a radio wave intensity measurement unit for receiving first radio wave intensities of radio waves received from a plurality of access points and for associating the received first radio wave intensities with the identifiers of the access points, and a moving/stationary determination unit for determining whether the terminal is moving or stationary; and a position information acquisition server having a position information table in which second radio wave intensities of the radio waves received beforehand from the plurality of access points are associated with position information indicating positions at which the radio waves were received beforehand, and a radio-wave-intensity/position conversion unit for retrieving, in response to a determination result from the moving/stationary determination unit indicating that the terminal has stopped, the second radio wave intensities corresponding to the received first radio wave intensities, which have been associated with the identifiers of the access points, from the position information table and for acquiring position information corresponding to the retrieved second radio wave intensities.

### Advantageous Effects of Invention

According to the present invention, the position of a terminal is not detected while the terminal is moving because a person has few opportunities to use the terminal while the terminal is moving, with the result that the energy consumption of a target terminal, whose position information is to be obtained, can be restrained by detecting the position of the target terminal only when the terminal is under its stationary status.

### BRIEF DESCRIPTION OF DRAWINGS

FIG. 1 shows the configuration of a position information acquisition system.

FIG. 2 is the processing flowchart of a radio wave intensity measurement unit.

FIG. 3 is the processing flowchart of a moving/stationary determination unit 11.

FIG. 4 is the processing flowchart of a moving/stationary status reception unit.

FIG. 5 shows variation examples of radio wave intensities owing to the moving/stopping of a terminal.

FIG. 6 is the processing flowchart of a radio-wave-intensity/position conversion unit 23.

FIG. 7 shows an example of a position information management DB.

FIG. 8 shows the configuration of a terminal according to a second embodiment.

### DESCRIPTION OF EMBODIMENTS

A position information acquisition system according to these embodiments includes a terminal and a position information acquisition server that acquires the position information of this terminal. The terminal includes a radio wave intensity measurement unit for receiving first radio wave intensities of radio waves received from plural access points and for associating the received first radio wave intensities with the identifiers of the access points, and a moving/stationary determination unit for determining whether the terminal is moving or stationary. The position information acquisition server includes a position information table in which second radio wave intensities of the radio waves received beforehand from the plural access points are associated with position information indicating positions at which the radio waves were received beforehand and a radio-wave-intensity/position conversion unit for retrieving, in response to a determination result from the moving/stationary determination unit indicating that the terminal has stopped, the second radio wave intensities corresponding to the received first radio wave intensities, which have been associated with the identifiers of the access points, from the position information table and for acquiring position information corresponding to the retrieved second radio wave intensities.

Hereinafter, a position information acquisition system and a method used in the system will be explained as a first embodiment, and a position information acquisition terminal that brings in the function of the abovementioned position information acquisition server will be explained as a second embodiment.

### First Embodiment

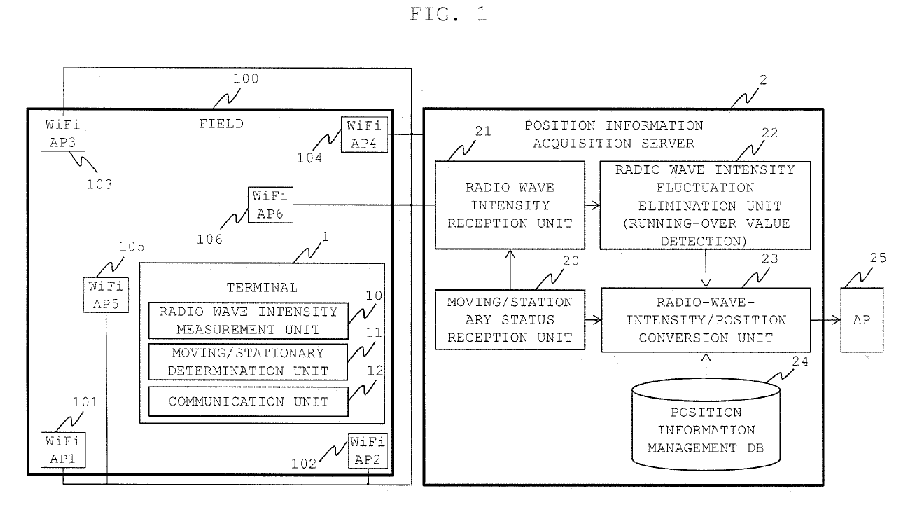

FIG. 1 shows the configuration of a position information acquisition system according to this embodiment. The position information acquisition system is a system that acquires the position of a terminal 1 in a field 100 using a position information acquisition server 2, and outputs the acquired position information of the terminal to applications that use this position information.

Wireless LAN access points 101 to 106 (hereinafter, the access point 101 will used as a representative) such as WiFi (Wireless Fidelity) access points are installed in the field 100. The terminal 1 communicates with other terminals and servers via the access point 101 or communicates with remote servers via a network coupled with the access point 101. In the position information acquisition system, the access point 101 is coupled with the position information acquisition server 2 via the network, and the position of the access point 101 in the field 100 is identified by the position information acquisition server 2.

In FIG. 1, although the field 100 is represented by a rectangle in order for the field 100 to be easily understandable, the actual field 100 is a store, a shopping area, a factory site, a certain district, or the like, so the shape of the field 100 is generally of various shapes. In addition, each floor of a building can be treated as a field 100, and a stereoscopic field 100 can be made by integrating fields 100 corresponding to individual floors.

The terminal 1 is a computer including a radio wave intensity measurement unit 10, a moving/stationary determination unit 11, and a communication unit 12. The terminal 1 further includes an acceleration sensor for detecting the moving/stationary status of the terminal 1, and is configured for the computer to bring in the output of the acceleration sensor. Communications among the abovementioned terminal 1 and the server and the like are performed by the communication unit 12. The terminal 1 includes an input/output screen and the like as user interfaces although they are not shown diagrammatically, and they will be explained hereinafter as needed.

The position information acquisition server 2 is a typical server including a CPU, a memory, and the like, and it further includes a moving/stationary status reception unit 20; a radio wave intensity reception unit 21; a radio wave intensity fluctuation elimination unit 22; radio-wave-intensity/position conversion unit 23; and a position information management DB 24.

An application 25 (abbreviated to the AP 25 hereinafter) is application software that uses position information about the terminal 1 acquired by the position information acquisition server 2. The AP 25 is executed by the position information acquisition server 2, other servers coupled to the position information acquisition server 2, the terminal 1, or other terminals in accordance with services provided by the AP 25.

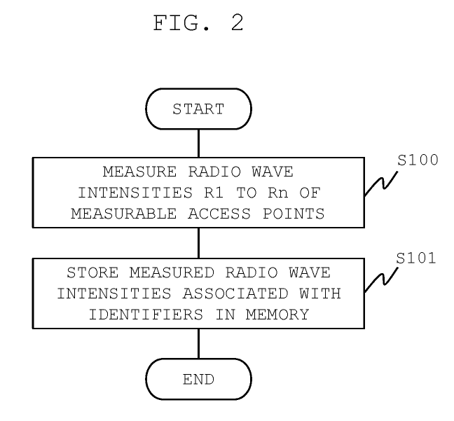

FIG. 2 shows the processing flowchart of the radio wave intensity measurement unit 10 of the terminal 1. The radio wave intensity measurement unit 10 measures a radio wave intensity received from the measurable access point 101 among the access points 101 to 106. Furthermore, the radio wave intensity measurement unit 10 obtains the MAC address of the access point 101 included in the radio wave received from the access point 101 as a piece of information(at step S100). The radio wave intensity measurement unit 10 stores the measured radio wave intensity in a memory in the terminal 1 in association with the MAC address of the access point 101 (at step S101). If the order of storing is correct, and a predefined cycle, which will be explained later, is observed, after-mentioned processing using the measured radio wave intensities can be executed, and additionally if the relevant measurement time data is stored in the memory in association with the above data, processing about the time changes of the radio wave intensities can be easily executed.

The position information acquisition system uses the MAC address of the access point 101 as the identifier of the access point 101. Alternatively, another type of identifier is prepared, and the MAC address can be converted to the prepared identifier.

In addition, because the radio wave intensity measurement unit 10 measures a radio wave intensity received from the measurable access point 101 among the access points 101 to 106, it does not matter so much that a radio wave intensity from a certain access point 101 cannot be measured because the radio wave from the certain point 101 is blocked by an obstacle. If a radio wave intensity cannot be measured, a very small value that cannot be really obtained, for example, −100 dB, is used as the relevant measurement value.

The processing executed by the radio wave intensity measurement unit 10 is activated by a cycle timer and is executed at predefined cycles. The predefined cycle can be selectively set from among 10 ms, 100 ms, and other cycles in consideration of the estimated moving velocity of the terminal 1, the number of access points 101 communicable with the terminal 1, and the like. Here, if the predefined cycle is short, the CPU load of the terminal 1 becomes heavy, and if the predefined cycle is long, it leads to the reduction of the accuracy of the radio wave intensity measurement owing to after-mentioned fluctuations with large amplitudes, therefore the predefined cycle is selectively set in accordance with the status of the field 100 and the capability of the terminal 1.

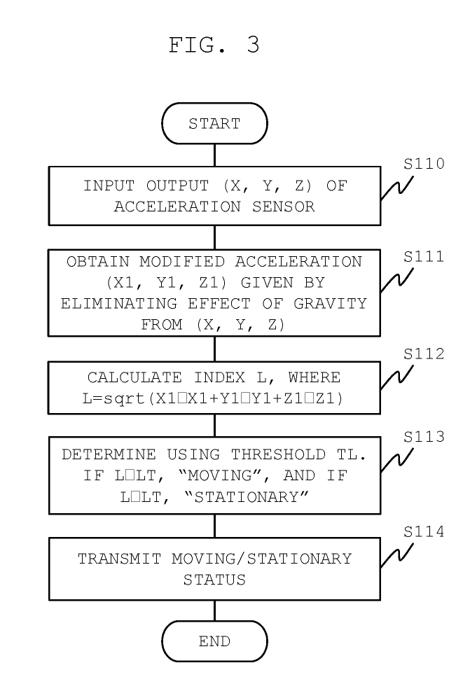

FIG. 3 shows the processing flowchart of the moving/stationary determination unit 11. The moving/stationary determination unit 11 brings in an acceleration (X, Y, Z) output from the acceleration sensor (at step S110). The moving/stationary determination unit 11 obtains a modified acceleration (X1, Y1, Z1) given by eliminating the effect of gravity acceleration from the acceleration (X, Y, Z) (at step S111). The moving/stationary determination unit 11 calculates an index L (=sqrt(X1*X1+Y1*Y1+Z1*Z1)) (at step S112). Here, sqrt represents a square root, the index L represents the absolute value of the combined vector of the modified acceleration. With the use of a threshold TL, if L>LT, it is determined that the terminal is “MOVING”, and if L<LT, it is determined that the terminal is “STATIONARY” (at step S113). The value of the threshold TL should be set in such a way that, because, even if a person bringing the terminal 1 with him/her is standing still, there is a case where his/her hand holding the terminal 1 is moving, the acceleration of the terminal 1 induced by the movement of his/her hand is eliminated. In reality, it is desirable that the threshold TL should be determined experimentally on the basis of the movements of plural tested persons. The moving/stationary determination unit 11 transmits the determination result, that is to say, “MOVING” or “STATIONARY” as a moving/stationary status to the position information acquisition server 2 via the access point 101 (at step S114). The processing at step S114 is executed by the communication unit 112 that is in charge of executing communications for various applications of the terminal 1.

The processing executed by the moving/stationary determination unit 11 is activated by a cycle timer and is executed at predefined cycles as is the case of the radio wave intensity measurement unit 10. Here, if the predefined cycle is short, the CPU load of the terminal 1 becomes heavy, and if the predefined cycle is long, there is a possibility that a detection delay (determination delay), which is as long as the time period of one predefined cycle, in detecting (determining) “MOVING” or “STATIONARY” arises, therefore the predefined cycle is selectively set in accordance with the status of the field 100 (such as the mobility of persons) and the capability of the terminal 1. If the predefined cycle for running the moving/stationary determination unit 11 is set to be equal to the predefined cycle for running the radio wave intensity measurement unit 10, only one timer is needed in the design of the terminal 1, therefore the configuration of the terminal 1 can be simplified.

As described later, while the terminal 1 moving, is unnecessary for the position information acquisition server 2 to acquire the position information of the terminal 1, therefore, if the operation of the radio wave intensity measurement unit 10 can be stopped, the CPU load of the terminal 1 can be reduced.

The process for initiating the execution of the radio wave intensity measurement unit 10 will be briefly explained. In the processing of the moving/stationary determination unit 11 shown in FIG. 3, because a determination result, that is to say, “MOVING” or “STATIONARY” has only to be obtained, it is unnecessary for an acceleration (X, Y, Z) output by the acceleration sensor or a modified acceleration (X1, Y1, Z1) to be stored in the memory in the terminal 1. However, in order to initiate the execution of the radio wave intensity measurement unit 10, the latest several modified accelerations (X1, Y1, Z1), with which the tendency of the variation of the acceleration can be found, are stored in the memory in the terminal 1 after the process of step S112 is finished (the number of the latest several modified accelerations is determined experimentally in accordance with the content of the following description so that the tendency of the variation of the acceleration from the moving status to the stationary status of the terminal 1 can be known). In order to reduce the usage amount of the memory, old modified accelerations (X1, Y1, Z1), which were measured a predefined number of times before, are deleted. The simplest determination method is a method in which, if the latest modified acceleration is smaller than the second latest modified acceleration, it is determined that the terminal 1 is transferring from a moving status to a stationary status. If the terminal 1 is transferring from the moving status to the stationary status, it is judged whether the index L is smaller than a threshold T′L, which is larger than the threshold TL, or not. If the index L is smaller than the threshold T′L, the cycle timer for activating the radio wave intensity measurement unit 10 is started. By activating the cycle timer, the execution of the radio wave intensity measurement unit 10 can be initiated. Generally speaking, the modified acceleration of the terminal 1 varies in synchronization with the movement of a Person moving his/her legs. Therefore, it is desirable that, after the moving average of memorized several modified accelerations is calculated, the moving average should be compared with the threshold T′L.

A process for stopping the execution of the radio wave intensity measurement unit 10 will be briefly explained. The cycle timer for activating the radio wave intensity measurement unit 10 is stopped in response to the determination result at step S113, that is to say, “MOVING”.

As described above, by controlling the start and stop of the execution of the radio wave intensity measurement unit 10, the radio wave intensity measurement unit 10 operates between the time just before the stop of the terminal 1 (the modified acceleration of the terminal 1 is smaller than the threshold T′L which is a threshold of the terminal 1 transferring to its stationary status) and the time of the moving start of the terminal 1, and does not operate during the time period of the terminal 1 moving, therefore the CPU load during the time period of the terminal 1 being stationary is lowered, and the energy consumption of the terminal 1 can be reduced.

Here, the threshold T′L is set larger than the threshold TL in order to measure a radio wave intensity before “STATIONARY” is determined at step S113, and it is also conceivable that the threshold T′L is set equal to the threshold TL. However, if both thresholds are set equal to each other, a radio wave intensity varies with time, and therefore there is a possibility that, in the case where the moving average of radio wave intensities is calculated, a situation where a necessary number of measurement data pieces of radio wave intensities are not prepared arises, which leads to the debasement of the accuracy of position information.

The moving/stationary status reception unit 20, the radio wave intensity reception unit 21, the radio wave intensity fluctuation elimination unit 22, and the radio-wave-intensity/position conversion unit 23 of the position information acquisition server 2 operate using the moving/stationary status reception unit 20 as a main processing unit.

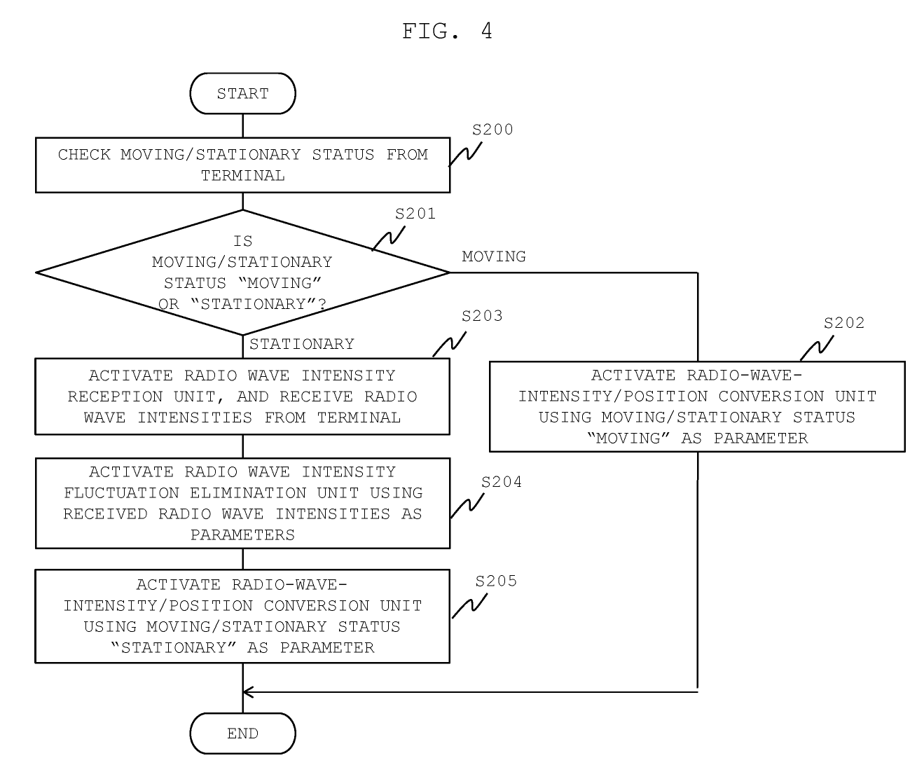

FIG. 4 shows the processing flowchart of the moving/stationary status reception unit 20 that controls each processing unit of the position information acquisition server 2.

The moving/stationary status reception unit 20 is activated in response to the reception of the moving/stationary status from the terminal 1. The moving/stationary status is a determination result of the moving/stationary status determination unit 11 of the terminal 1, that is to say, “MOVING” or “STATIONARY”. The moving/stationary status reception unit 20 checks the received moving/stationary status (at step S200). The moving/stationary status is determined (at step S201), and if the moving/stationary status is “MOVING”, the flow proceeds to step S202, and if the moving/stationary status is “STATIONARY”, the flow proceeds to step S203.

If the moving/stationary status is “MOVING”, the moving/stationary status reception unit 20 activates the radio-wave-intensity/position conversion unit 23 using the moving/stationary status “MOVING” as a parameter (at step S202), and finishes the processing of its own.

If the moving/stationary status is “STATIONARY”, the moving/stationary status reception unit 20 activates the radio wave intensity reception unit 21 (at step S203). The radio wave intensity reception unit 21 transmits radio wave intensity request to transmit to the terminal 1, and the terminal 1 associates measured radio wave intensities with the relevant MAC addresses, which have been already stored in the memory in the terminal 1, as identifiers, and transmits the measured radio wave intensities associated with the relevant MAC addresses to the position information acquisition server 2. At this time, if the order of storing the radio wave intensities and the relevant MAC addresses and the order of transmitting these data pieces to the position information acquisition server 2 cannot be assured, these data pieces are stored in the memory in association with the relevant measurement time data, and these data pieces associated with the relevant measurement time data are transmitted to the position information acquisition server 2, with the result that, by sorting the received data in the order of the measurement times, the position information acquisition server 2 can acquire the radio wave intensities in the order of the measurement times of the radio wave intensities. The radio wave intensity reception unit 21 associates the received MAC addresses with the measured radio wave intensities, and stores these data in a memory in the position information acquisition server 2.

In the case where radio wave intensities are not measured while the terminal 1 is moving, or in the case where radio wave intensities are transmitted from the terminal 1 in response to the radio wave intensity request to transmit from the radio wave intensity reception unit 21, the position information acquisition server 2 does not receive measurement data from the terminal 1 while the terminal 1 is moving, therefore the usage amount of the memory in the position information acquisition server 2 for storing the measurement data of radio wave intensities can be reduced.

It is conceivable that, without the radio wave intensity reception unit 21 transmitting a radio wave intensity request to transmit to the terminal 1, the radio wave intensity measurement unit 10 associates measured radio wave intensities with the relevant MAC addresses and transmits these data pieces to the position information acquisition server 2 at the time when the radio wave intensity measurement unit 10 stores the measured radio wave intensities in the memory. In this case, the activation of the radio wave intensity reception unit 21 executed by the moving/stationary status reception unit 20 (at step S203) becomes unnecessary.

The moving/stationary status reception unit 20 activates the radio wave intensity fluctuation elimination unit 22 (at step S204). The moving/stationary status reception unit 20 activates the radio-wave-intensity/position conversion unit 23 using the moving/stationary status “STATIONARY” as a parameter in response to the end of the processing of the radio wave intensity fluctuation elimination unit 22 (at step S205), and finishes the processing of its own.

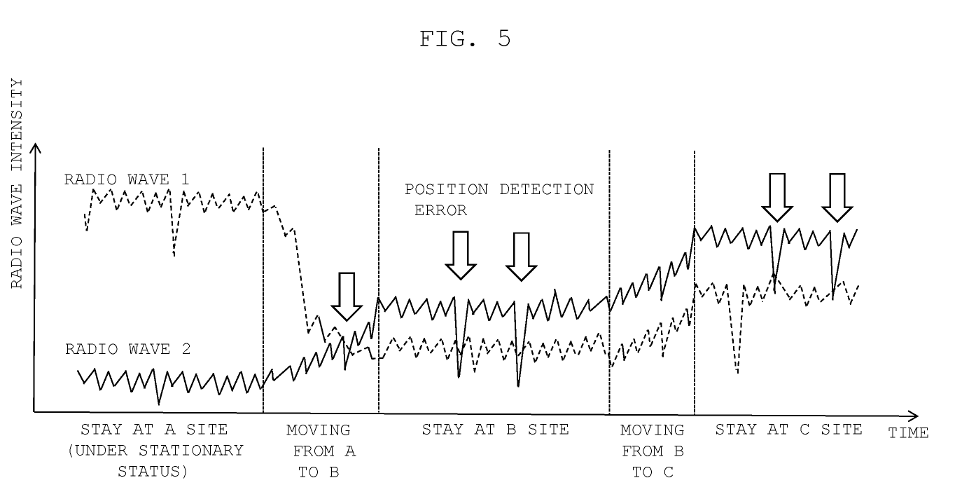

The processing of the radio wave intensity fluctuation elimination unit 22 will be explained. FIG. 5 shows variation examples of radio wave intensities owing to the moving/stopping of the terminal 1. These examples are the measurement results of radio wave intensities that are continuously measured at predefined cycles even when the terminal 1 is moving without stopping the operation of the radio wave intensity measurement unit 10 during the time period of the terminal 1 being stationary.

The horizontal axis of FIG. 5 represents time, and shows the passage of time from a time point when the terminal 1 is stationary at A site to a time point when the terminal 1 is stationary at C site through a time point when the terminal 1 is stationary at B site. The vertical axis represents radio wave intensity, and shows the radio wave intensity of a radio wave 1 that the terminal 1 receives from an access point and the radio wave intensity of a radio wave 2 that the terminal 1 receives from another access point. The variations of the radio wave intensities with respect to the time axis shown in FIG. 5 are plotted on the basis of the variations of the radio wave intensities that are actually measured in units of dB. As shown in FIG. 5, although the terminal 1 is stationary, the radio wave intensities momentarily vary (fluctuate), and in some cases the radio wave intensities considerably vary as shown by “POSITION DETECTION ERROR” in FIG. 5. Because the position information of the terminal 1 is acquired as described later using these radio wave intensities, the large variations (fluctuations with large magnitudes, running-over values) of the radio wave intensities makes position information to be acquired erroneous (reduces the accuracy of position detection).

The radio wave intensity received from the access point 101 at the terminal 1 often fluctuates owing to the effects of multipaths and fadings. In order to solve this problem about these fluctuations, some related techniques are proposed in which the average value of radio wave intensities measured three to five times is adopted. However, there are some cases where adopting the average value cannot solve this problem when the magnitudes of fluctuations are large, and although, if the number of measurements is increased, it becomes possible to cope with the large reductions of radio wave intensities, there arises a problem that the response is worsened, that is to say, a position detection delay or a position information acquisition delay is generated. Because the former induces a position detection error, it cannot be overlooked. On the other hand, the latter, that is to say, the position detection delay, can become negligible by setting the predefined cycle, at which the radio wave intensity measurement unit 10 is activated, to a cycle smaller enough (several orders of magnitude smaller) in comparison with a time interval during which a person moves through a predefined distance.

For example, a person moves at a speed 3.6 km/h, it takes 0.1 second (100 milliseconds) for him/her to move through 10 centimeters. Therefore, if the predefined cycle, at which the radio wave intensity measurement unit 10 is activated, is set to 10 milliseconds, a position detection delay of several tens of seconds corresponds to a detection position error of several centimeters. However, if the accuracy of position detection required by the position detection executed by the terminal 1 regarding the movement of a person is the size of a person's body (size of an image obtained by projecting the body of the person onto a floor) or a length equivalent to one step of the person (50 to 60 centimeters), the accuracy is sufficient, therefore the abovementioned position detection delay is negligible.

Referring to FIG. 5, it is noteworthy that a fluctuation having large magnitudes conspicuously appear in one measurement of data, and fluctuation of the next measurement of data returns to the level of former fluctuations (with their magnitudes within a small range). Although, if a cycle, at which the radio wave intensity measurement unit 10 is activated, is shortened as described above, fluctuations are observed not only in one measurement of data but also continuously observed in two or three times of measurement data, it is noteworthy anyway that the fluctuations return to the level of former fluctuations.

Once the values of radio wave intensities return to their former values, the measurement data of radio wave intensities is used without using the running-over values of radio wave intensities that show fluctuations with large magnitudes (in other words, the running-over values are eliminated). The above method is a method in which attention is paid to radio waves from a certain access point 101, and running-over values included in the radio waves are eliminated. As an alternative method, there is a method in which radio wave intensities from plural access points are compared with each other. For example, this method is a method in which, when the radio wave intensities of radio waves from a certain access point largely vary but the radio wave intensities of radio waves from another access point are within a range of fluctuations with small magnitudes, the radio wave intensities that largely vary are eliminated as running-over values. In this case, it is conceivable that radio waves from access points from which running-over values are measured are determined by applying majority logic to the magnitudes of fluctuations of radio wave intensities of radio waves from plural access points.

The radio wave intensity fluctuation elimination unit 22 eliminates running-over values of fluctuations of the measured radio wave intensities using any of the abovementioned methods. Although, if the running-over values are eliminated, some data pieces are lost, each lost data piece is filled with a radio wave intensity measured just before the relevant running-over value is measured under the assumption that the radio wave intensity just before the relevant running-over value would continue. As described above, running-over values are eliminated using the fact that the values of radio wave intensities return to their former values, therefore plural blocks of measurement data from each access point 101 are conventionally stored in the memory. Furthermore, fluctuations with small magnitudes can also be smoothed by calculating the moving average of plural blocks of measurement data of radio wave intensities.

Here, each radio wave intensity with a large magnitude (each running-over value) is detected by comparing a difference between the current measurement of data and the latest measurement of data or a difference between the current moving average and the latest moving average with a predefined threshold.

In addition, if the field 100 provides a radio wave environment where the effects of multipaths and fadings are negligible, that is to say, fluctuations with large magnitudes (running-over values) are not generated in radio wave intensities, it is unnecessary for the position information acquisition server 2 to include the radio wave intensity fluctuation elimination unit 22.

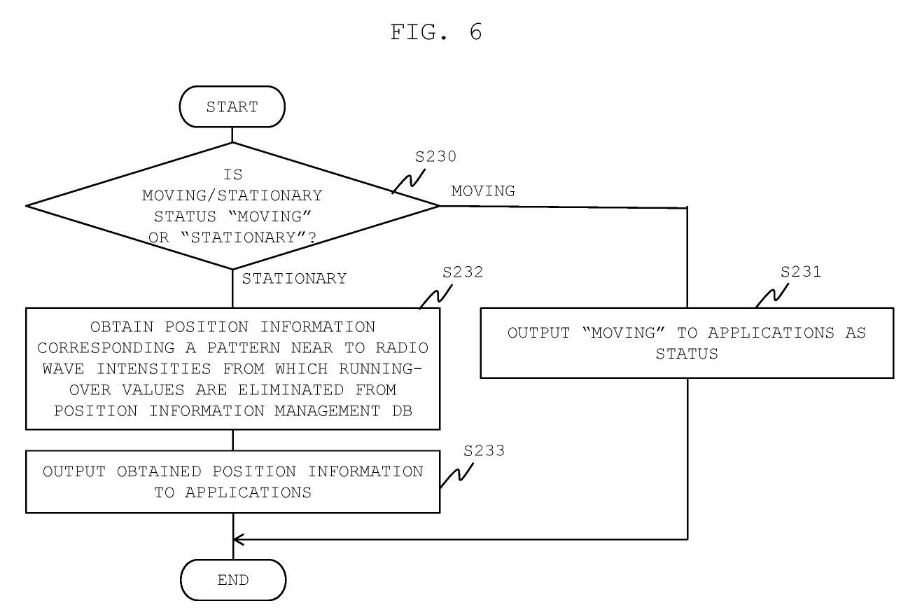

FIG. 6 shows the processing flowchart of the radio-wave-intensity/position conversion unit 23. The radio-wave-intensity/position conversion unit 23 is activated by the moving/stationary status reception unit 20 using the moving/stationary status “MOVING” or “STATIONARY” as a parameter. When the moving/stationary status is “STATIONARY, radio wave intensity data, which was transmitted from the access point 101 in the terminal 1, received by the radio wave intensity reception unit 21 from the terminal 1, stored in the memory, and from which running-over values of the measured radio wave intensities were eliminated, has been stored in the memory in the position information acquisition server 2.

The radio-wave-intensity/position conversion unit 23 determines whether the moving/stationary status, which is an activation parameter, is “MOVING” or “STATIONARY” (at step S230), and if the moving/stationary status is “MOVING”, the flow proceeds to step S231, and if the moving/stationary status is “STATIONARY”, the flow proceeds to step S232.

When the moving/stationary status is “MOVING”, the radio-wave-intensity/position conversion unit 23 outputs the moving/stationary status “MOVING” which shows that the terminal 1 is moving, to AP 25 (at step S231), and finishes the processing of its own. There may be some cases where the radio-wave-intensity/position conversion unit 23 outputs the moving/stationary status to the AP 25 via a network depending on the coupling status with the abovementioned servers or terminals which execute the AP 25. As described above, because the terminal 1 does not output the position information about the terminal 1 to the AP 25, it is unnecessary for the terminal 1 to measure radio wave intensities from the access point 101 when the terminal 1 is moving. The AP 25 executes the relevant processing while the terminal 1 is moving. For example, in the case where the field 100 is a shop, the AP 25 executes processing such as introducing loyalty programs or new commercial goods to the terminal 1.

When the moving/stationary status is “STATIONARY”, the radio-wave-intensity/position conversion unit 23 acquires position information corresponding to a radio wave intensity pattern (a combination of radio wave intensities from plural positions), which is near to the radio wave intensity from which the running-over values are eliminated, from the position information management DB 24 (at step S232). Although there may be a case where a radio wave intensity pattern completely coincides with a radio wave intensity from which the running-over values are eliminated, generally speaking such a case seldom occurs owing to fluctuations and differences between measurement conditions. How to acquire position information from the position information management DB 24 will be described in detail later. The radio-wave-intensity/position conversion unit 23 outputs the acquired position information about the terminal 1 to the AP 25 (at step S233). The AP 25 executes the relevant processing while the terminal 1 is stationary. For example, in the case where the field 100 is a shop, the AP 25 executes processing such as explaining commercial goods near to the position shown by the position information of the terminal 1 in detail.

How to acquire position information from the position information management DB 24 will be described below. Data of the position information management DB 24 is prepared beforehand on the basis of actual measurement values of radio wave intensities (or the average values of actual plural measurement values). Therefore the data of the position information management DB 24 is updated in accordance with the addition, deletion of access points, the change of the installation positions of access points, and the situational change of the field 100 (such as the addition and deletion of obstacles that block radio waves).

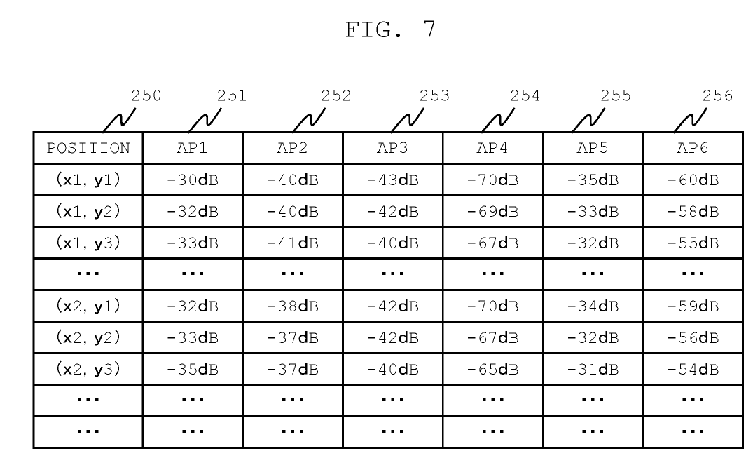

FIG. 7 shows an example of the position information management DB. The example shown in FIG. 7 is a position information table that shows position information, and shows radio wave intensities 251 to 256 respectively transmitted from the access points AP1 to AP6 (101 to 106) at positions 250 in the field 100 shown in FIG. 1. For example, the position information table shows that a radio wave intensity from access point AP1 (101) at a position (x1, y1) is −30 dB. Here, a distance between any two positions of positions 250 situated next to each other is large enough for the abovementioned accuracy of position detection (50 to 60 centimeters).

It will be assumed that radio wave intensities (or moving averages), which are obtained from individual access points AP1 to AP6 (101 to 106) and from which running-over values have been already eliminated, are −30 dB, −38 dB, −40 dB, −69 dB, −32 dB, and −56 dB respectively, and how to acquire position information will be explained. The radio-wave-intensity/position conversion unit 23 retrieves a radio wave intensity pattern that is nearest to a combination of these radio wave intensities from the position information management DB 24. For example, if the position of the terminal 1 is (x1, y1), the radio-wave-intensity/position conversion unit 23 obtains radio wave intensities −30 dB, −40 dB, −43 dB, −70 dB, −35 dB, and −60 dB respectively transmitted from AP1, AP2, AP3, AP4, AP5, and APS.

Here, let the radio wave intensities −30 dB, −40 dB, −43 dB, −70 dB, −35 dB, and −60 dB be represented by R111, R211, R311, R411, R511, and R611 respectively, and an evaluation function J=(R10−R111)+(R20−R211)²+(R30−R311)²+(R40−R411)²+(R50−R511)²+(R60−R611)² is calculated, resulting in the value of the evaluation function 39. The radio-wave-intensity/position conversion unit 23 calculates J for each of the positions 250 as above, and a Position (xm, yn) for which J shows the smallest value is determined to be the position information of the terminal 1. In the example shown in FIG. 7, a position (x1, y2) is obtained as position information corresponding to the smallest value of J.

In the above description, the evaluation function J is calculated about all positions 250 stored in the position information management DB 24. However, alternatively, let's consider the value of an access point having the largest radio wave intensity among the access points AP1 to AP6 (101 to 106) as a central value (in the above example, the access point having the largest radio wave intensity is AP1, and the central value is −30 dB), and J is calculated about radio wave intensity patterns having their intensity values from −kdB+the central value to +k dB+central value. As a result, the calculation amount brought about by the calculation executed by the radio-wave-intensity/position conversion unit 23 and the memory capacity used for temporarily memorizing the values of J corresponding to individual positions 250 can be drastically reduced. Alternatively, in the calculation of the above evaluation function J, it is conceivable that, without using radio wave intensities from all the access points, some radio wave intensities, for example, the radio wave intensities of three events having large radio wave intensities, are used in accordance with a specific rule for calculating the evaluation value.

Although it has been described so far that the position information of the terminal 1 can be acquired, if there are plural terminals, it is common that the terminals have different reception sensitivities from an access point 101 respectively. The following processing is executed on terminals having different reception sensitivities. Radio wave intensities measured by radio wave intensity measurement unit 10 are treated in such a way that the largest value among measurement data of radio wave intensities from plural access points 101 at any of the radio wave intensity measurement unit 10, the radio wave intensity reception unit 21, the radio wave intensity fluctuation elimination unit 22, and the radio-wave-intensity/position conversion unit 23, through which the measurement data of radio wave intensities pass, is set to 0 dB, and measurement data of radio wave intensities from other access points 101 are normalized. For example, as described in the above example, if the radio wave intensities (or moving averages) which are obtained from individual access points AP1 to AP6 (101 to 106) are −30 dB, −38 dB, −40 dB, −69 dB, −32 dB, and −56 dB respectively, these values become 0 dB, −8 dB, −10 dB, −39 dB, −2 dB, and −26 dB respectively when these values are normalized. In concordance with this normalization, radio wave intensity patterns stored in the position information management DB 24 are normalized. For example, a normalized radio wave intensity pattern at the position (x1, y1) is (0 dB, −10 dB, −13 dB, −40 dB, −5 dB, and −30 dB). By normalizing radio wave intensities in such a way, differences among reception sensitivities that depend on the terminals can be coped with.

According to this embodiment, the position of the terminal is not detected while the terminal is moving because a person has few opportunities to use the terminal while the terminal is moving, and the position of a terminal is detected while the terminal is stationary, with the result that the energy consumption of the terminal can be restrained.

Furthermore, according to this embodiment, in order to cope with fluctuations of radio wave intensities from access points owing to the effects of multipaths and fadings, the running-over values of the radio wave intensities are eliminated, with the result that the occurrence of position detection errors can be deterred.

### Second Embodiment

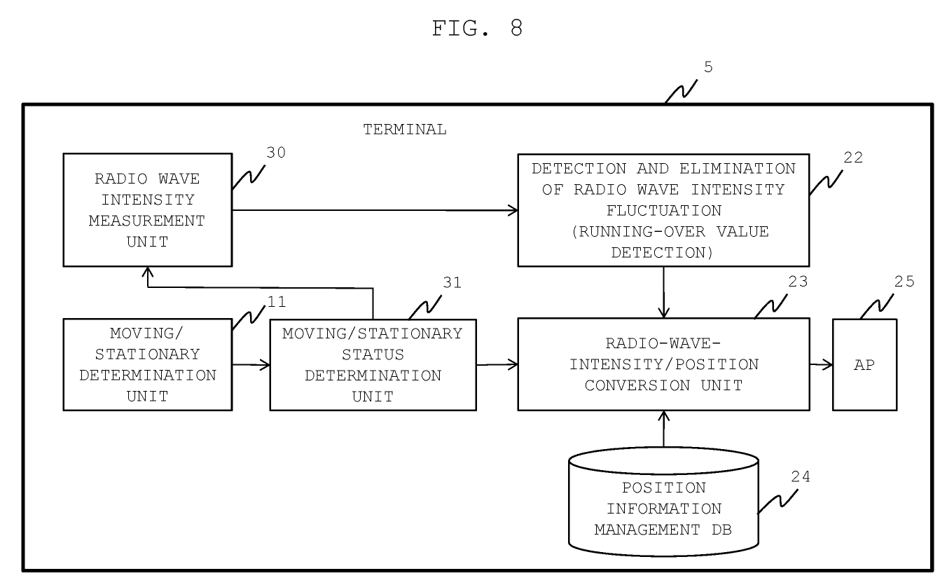

FIG. 8 shows the configuration of the terminal according to this embodiment. The configuration of the terminal 5 is equivalent to a configuration obtained by bringing in the processing units of the position information acquisition server 2 in the terminal 1. Thanks to the configuration in which the processing units are brought in, it becomes unnecessary that the terminal 1 and the position information acquisition server 2 hold communication with each other, therefore the communication unit 12 and the radio wave intensity reception unit 21 used in the first embodiment become unnecessary. However, although the communication unit 12 is necessary in order to deal with communication in association with the execution of applications made by the terminal 5 as the terminal 5's primary role, the communication unit 12 is not shown in FIG. 8.

Hereinafter, mainly different points between this embodiment and the first embodiment will be described. The terminal 5 includes a radio wave intensity measurement unit 30; a moving/stationary determination unit 11; a moving/stationary status determination unit 31; a radio wave intensity fluctuation elimination unit 22; a radio-wave-intensity/position conversion unit 23; a position information management DB 24, and further includes an application 25 (abbreviated to the AP 25 hereinafter) which uses the acquired position information of the terminal 5.

In the first embodiment, an explanation has been made in which the radio wave intensity measurement unit 10 transmits a measured radio wave intensity after associating the relevant MAC address with the radio wave intensity to the position information acquisition server 2 in response to the radio wave intensity request to transmit from the radio wave intensity reception unit 21 or at the time when the measurement of the radio wave intensity is made. Because it is not necessary for the radio wave intensity measurement unit 30 to transmit a measured radio wave intensity, the radio wave intensity measurement unit 30 stores the radio wave intensity in a memory in the terminal 5 after associating the relevant MAC address with the radio wave intensity, and then the radio wave intensity fluctuation elimination unit 22 has only to access the MAC address and the measured radio wave intensity that are stored in the memory.

In addition, in the first embodiment, an explanation has been made in which it is conceivable that the start/stop of the radio wave intensity measurement unit 10 is controlled by the moving/stationary determination unit 11. Although it is all right that the same scheme as above is also adopted in this embodiment, the start/stop of the radio wave intensity measurement unit 10 can be controlled in accordance with a moving/stationary status “STATIONARY” or “MOVING” determined by the moving/stationary status determination unit 31 which will be described later. An arrow from the moving/stationary status determination unit 31 to the radio wave intensity measurement unit 10 in FIG. 8 indicates a control mode which is not used in the first embodiment.

Although the moving/stationary status determination unit 31 executes processing similar to processing executed by the moving/stationary status reception unit 20 in the first embodiment, an activation condition under which the moving/stationary status determination unit 31 is activated in response to the determination result of the moving/stationary determination unit 11 is different from that used in the first embodiment. Alternatively, it is conceivable that the moving/stationary status determination unit 31 controls the start/stop of the abovementioned radio wave intensity measurement unit 10.

According to the this embodiment, as is similar to the case of the first embodiment, the position of a terminal is not detected while the terminal is moving because a person has few opportunities to use the terminal while the terminal is moving, with the result that the energy consumption of the terminal can be restrained by detecting the position of the terminal only when the terminal is stationary.

In addition, according to this embodiment, as is similar to the case of the first embodiment, in order to cope with fluctuations of radio wave intensities from access points owing to the effects of multipaths and fadings, the running-over values of the radio wave intensities are eliminated, with the result that the occurrence of position detection errors can be restrained.

Furthermore, according to this embodiment, because the processing for detecting the position of the terminal as well as applications that use the detected position information are completed within the terminal, the accuracy of position detection necessary for executing the applications of individual terminals have only to be secured, therefore the capacity of the position information management DB 24 can be greatly reduced depending on the required accuracy of position detection.

### LIST OF REFERENCE SIGNS

1: Terminal, 2: Position Information Acquisition Server, 5: Terminal, 10: Radio Wave Intensity Measurement Unit, 11: Moving/Stationary Determination Unit, 12: Communication Unit, 20: Moving/Stationary Status Reception Unit, 21: Radio Wave Intensity Reception Unit, 22: Radio Wave Intensity Fluctuation Elimination Unit, 23: Radio-Wave-Intensity/Position Conversion Unit, 24: Position Information Management DB, 25: Application, 30: Radio Wave Intensity Measurement Unit, 31: Moving/Stationary Status Determination Unit, 100: Field, 101 to 106: Access Points

1. A position information acquisition system comprising:
a terminal having:
a radio wave intensity measurement unit for receiving first radio wave intensities of radio waves received from a plurality of access points and for associating the received first radio wave intensities with the identifiers of the access points; and
a moving/stationary determination unit for determining whether the terminal is moving or stationary; and
a position information acquisition server having:
a position information table in which second radio wave intensities of the radio waves received beforehand from the plurality of access points are associated with position information indicating positions at which the radio waves were received beforehand; and
a radio-wave-intensity/position conversion unit for retrieving, in response to a determination result from the moving/stationary determination unit indicating that the terminal has stopped, the second radio wave intensities corresponding to the received first radio wave intensities, which have been associated with the identifiers of the access points, from the position information table and for acquiring the position information corresponding to the retrieved second radio wave intensities.

2. The position information acquisition system according to claim 1,
wherein the position information acquisition server includes a radio wave intensity fluctuation elimination unit for eliminating running-over values that are included in the received first radio wave intensities and have fluctuation amplitudes larger than a predefined threshold, and
the radio-wave-intensity/position conversion unit retrieves the second radio wave intensities corresponding to the first radio wave intensities, from which the running-over values have been eliminated, from the position information table.

3. The position information acquisition system according to claim 1,
wherein the radio wave intensity measurement unit receives the first radio wave intensities during the time period of the terminal being stationary which is obtained as a result determined by the moving/stationary determination unit.

4. A position information acquisition terminal comprising:
a radio wave intensity measurement unit for receiving first radio wave intensities of radio waves received from a plurality of access points and for associating the received first radio wave intensities with the identifiers of the access points;
a moving/stationary determination unit for determining whether a terminal is moving or stationary;
a position information table in which second radio wave intensities of the radio waves received beforehand from the plurality of access points are associated with position information indicating the positions at which the radio waves were received beforehand; and
a radio-wave-intensity/position conversion unit for retrieving, in response to a determination result from the moving/stationary determination unit indicating that the terminal has stopped, the second radio wave intensities corresponding to the received first radio wave intensities, which have been associated with the identifiers of the access points, from the position information table and for acquiring the position information corresponding to the retrieved second radio wave intensities.

5. The position information acquisition terminal according to claim 4, further comprising:
a radio wave intensity fluctuation elimination unit for eliminating running-over values that are included in the received first radio wave intensities and have fluctuation amplitudes larger than a predefined threshold,
wherein the radio-wave-intensity/position conversion unit retrieves the second radio wave intensities corresponding to the first radio wave intensities, from which the running-over values have been eliminated, from the position information table.

6. The position information acquisition terminal according to claim 4,
wherein the radio wave intensity measurement unit receives the first radio wave intensities during the time period of the terminal being stationary which is obtained as a result determined by the moving/stationary determination unit.

7. A position information acquisition method used in a position information acquisition system having a position information table in which second radio wave intensities of radio waves received beforehand from a plurality of access points are associated with position information indicating positions at which the radio waves were received beforehand,
wherein the position information acquisition system:
receives first radio wave intensities of radio waves, which are received by a terminal from the plurality of access points, and associates the received first radio wave intensities with the identifiers of the access points;
determines whether the terminal is moving or stationary; and
retrieves, in response to the stoppage of the operation of the terminal, the second radio wave intensities corresponding to the received first radio wave intensities, which have been associated with the identifiers of the access points, from the position information table and acquires the position information corresponding to the retrieved second radio wave intensities.

8. The position information acquisition method according to claim 7,
wherein the position information acquisition system:
eliminates running-over values that are included in the received first radio wave intensities and have fluctuation amplitudes larger than a predefined threshold; and
retrieves the second radio wave intensities corresponding to the first radio wave intensities, from which the running-over values have been eliminated, from the position information table.

9. The position information acquisition method according to claim 7,
wherein the position information acquisition system receives the first radio wave intensities during the time period of the terminal being stationary.
